(19) United States
(12) Patent Application Publication
(10) Pub. No.: US 2011/0180338 A1
(43) Pub. Date: Jul. 28, 2011

(54) GENERATOR MOTOR AND ELECTRIC AUTOMOBILE, ELECTRIC SHIP

(76) Inventors: Min Lu, Guangdong (CN); Yuanxiang Lu, Hainan (CN)

(21) Appl. No.: 13/054,082

(22) PCT Filed: Jul. 29, 2009
(86) PCT No.: PCT/CN2009/072968

§ 371 Date: Mar. 31, 2011

(30) Foreign Application Priority Data
Jul. 31, 2008 (CN) 200810142219.X

(51) Int. Cl. B60L 11/18; H02K 47/00; B60L 11/00; B63H 21/17

(52) U.S. Cl. 180/65.31; 310/113; 180/65.7; 416/170 R

(57) ABSTRACT

A generator motor, an electric automobile and an electric ship driven by this kind of generator motor are provided. Said generator motor includes a rotating shaft (180), a generator stator (110), a rotator (120) and a motor stator (130), the generator stator (110), the rotator (120) and the motor stator (130) are installed on the rotating shaft (180) form the inner side to the outer side sequently. A generator rotator winding and a motor rotator winding are disconnected and arranged alternately on said rotator (120). The generator motor runs driven by the external electric supply, and the generating part generates electric power at the same time. The generator motor supplies the power to the electric automobile and the electric ship, which consumes the electric quantity of the storage cell (322) and supplements electric quantity to the storage cell at the same time, and the using time of the storage cell is prolonged.

### FIELD OF THE PATENT APPLICATION

The present patent application generally relates to motors, more particularly to a generator motor, an electric automobile and an electric ship driven by such generator motor.

### BACKGROUND OF THE PATENT APPLICATION

As rapid development of industries and rapid increase of the quantity of automobiles in the cities, nature energy sources such as oil are gradually reduced, and great amount of discharged harmful gas seriously pollutes the atmosphere, speeds up green house effect of the earth, and continuously worsens environment for people living. Therefore, problems with respect to shortage of energy sources, air pollution are focus concerned by countries all over the world nowadays, and various kinds of automobiles driven by other green energy such as electric energy, solar energy occur.

An electric automobile driven by electric energy generally carries a storage cell, through which the motor is supplied with power to run and drive a shaft rotating, and in turn drive a driving wheel via differential gears. Since electric power of the storage cell is limited, and re-charge of the storage cell needs to wait for a period of time, application range of such electric automobiles is greatly restricted.

It is known that the motor generates electromagnetic torque through interaction between a rotary magnetic field of the stator and induced current of the rotator, and then output it via the shaft. A certain proportion of power loss exists when the motor runs. When the motor is used on an automobile with storage cell having limited electric quantity, such power loss will speed up consumption of electric quantity of the storage cell. Therefore, studies on how to reduce power loss of the motor to make it more power saving and even on reutilization of power loss of the motor, become a key point of research.

### SUMMARY OF THE PATENT APPLICATION

Aiming at the disadvantages of the motors in the prior art, the present application is intended to provide a generator motor, an electric automobile and an electric ship driven by such kind of generator motor in order to achieve recycling of energy.

According to an aspect of the present application, a generator motor is provided, comprising a rotating shaft, a generator stator, a rotator, and a motor stator, the generator stator, the rotator, and the motor stator are installed on the rotating shaft sequentially from inside to outside, wherein the generator stator has a plurality of first protrusions symmetrically distributed along its circumferential direction, and a generator stator winding is arranged on said plurality of first protrusions; the motor stator has a plurality of second protrusions extending inward and symmetrically distributed along its inner wall, and a motor stator winding is arranged on said plurality of second protrusions; the rotator includes a plurality of first partial tubular members which have a first inner diameter and a first outer diameter, and a corresponding plurality of second partial tubular members which have a second inner diameter and a second outer diameter, and the plurality of first partial tubular members and the plurality of second partial tubular members are connected alternately with each other along its circumferential direction, the first inner diameter is less than the second inner diameter, and the first outer diameter is less than the second outer diameter, wherein a generator rotator winding is arranged on the plurality of first partial tubular members, and a motor rotator winding is arranged on the plurality of second partial tubular members.

In an embodiment of the present application, the generator stator and the motor stator are installed on the rotating shaft of the generator motor via bearings respectively. The rotator is fixedly installed on the rotating shaft of the generator motor via sleeves.

According to another aspect of the present application, an electric automobile is provided, comprising a storage cell, a motor, a clutch, a gear box, a universal joint, a rear bridge, a differential gear, and a plurality sets of front wheels and rear wheels, motive power generated by the motor when it is powered from the storage cell to run, being transferred to the rear wheels via the clutch, the gear box, the universal joint, the rear bridge and the differential gear installed on the central shaft, and then via a half shaft, wherein the motor is a generator motor of the present application as described above, a motor stator winding of the generator motor is connected externally to the storage cell, and electric current generated from a generator rotator winding of the generator motor is connected to the storage cell.

In an embodiment of the present application, at least a generator driven by the shaft is arranged on a non-output terminal of the shaft of the generator motor, and at least another generator driven by the shaft is arranged on the shaft between the generator motor and the clutch.

In an embodiment of the present application, at least a generator driven by the central shaft of the electric automobile is arranged on the central shaft to supply power to the storage cell.

In an embodiment of the present application, each of the plurality sets of front wheels and rear wheels is provided with a generator which runs with rotation of the corresponding wheel to supply power to the storage cell.

According to yet another aspect of the present application, an electric ship is provided, comprising at least one propulsion system, wherein in each propulsion system a motor is powered by a storage cell to drive a screw propeller running, and said motor is a generator motor of the present application as described above, a motor stator winding of the generator motor is connected externally to the storage cell, and electric current generated from a generator rotator winding of the generator motor is connected to the storage cell.

In an embodiment of the present application, on a rotating shaft of each propulsion system, at least one generator which is driven by the shaft is arranged to supply power to the storage cell.

In an embodiment of the present application, at the bottom of the electric ship, at least one hydraulic turbine driven by water flow is arranged.

The generator motor, the electric automobile and the electric ship in accordance with embodiments of the present application have the following advantages: the present application shares a special designed rotator for the generator rotator and the motor rotator, such that the generator and the motor are integrated into a whole. When the motor portion is initiated with external power supply to run, the generator portion is driven to generate electric energy simultaneously. The generated electric energy may be used as a supplement to the external power supply of the motor portion, thereby power consumption of the generator motor is significantly reduced, and recycling and reuse of kinetic energy is achieved. In the electric automobile and the electric ship driven by such generator motors, storage cells are used to supply power for the generator motor to initiate the automobile and the ship, and then the generator portion of the generator motor runs along with operation of the motor portion to generate electric energy, which is supplied to the storage cells. In such a way, during the traveling of the automobile and the ship, the generator motors can continuously supplement partial electric quantity to the storage cells while they are consuming electric quantity of the storage cells, thus service time of the storage cells is prolonged, and traveling distance of the automobile and the ship is extended. The electric automobile and the electric ship are more energy-saving through recycling of kinetic energy.

### BRIEF DESCRIPTION OF THE DRAWINGS

FIG. 1 is a structural diagram showing a generator motor in accordance with a first embodiment of the present application.

FIG. 2 is a diagram showing assembly of the generator motor as shown in FIG. 1 in accordance with the first embodiment of the present application.

FIG. 3 is a structural diagram showing a generator motor in accordance with a second embodiment of the present application.

FIG. 4 is a diagram showing a chassis transmission system of an electric automobile driven by a generator motor in accordance with an embodiment of the present application.

FIG. 5 is a diagram showing an electric ship driven by a generator motor in accordance with an embodiment of the present application.

FIG. 6 is a diagram showing an electric ship in accordance with another embodiment of the present application.

### DETAILED DESCRIPTION

These and other aspects of the present application will be further described from the following description of the embodiments taken in conjunction with the drawings.

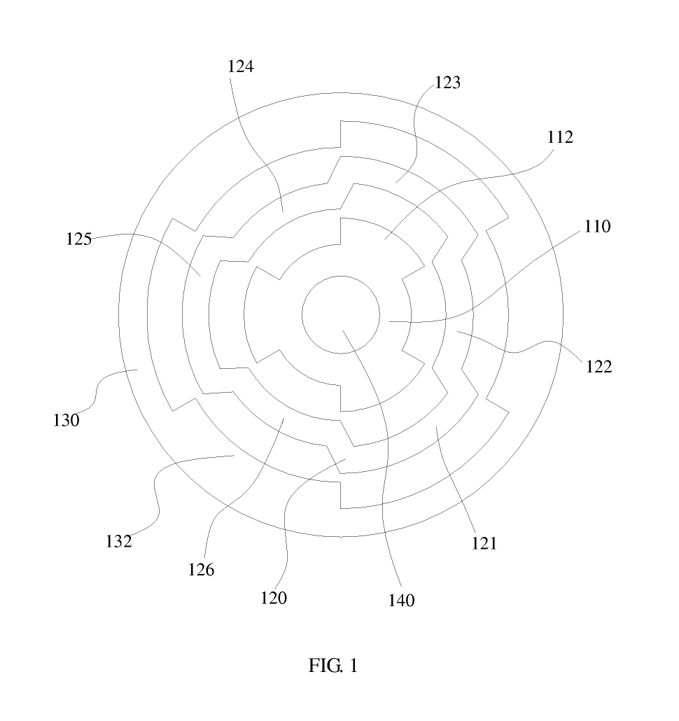

FIG. 1 is a structural diagram showing a generator motor in accordance with a first embodiment of the present application. As shown in FIG. 1, a generator stator 110, a rotator 120 and a motor stator 130 are arranged sequentially from inside to outside within a housing (not shown) of the generator motor. The generator stator 110 comprises a columnar body and three arc-shaped protrusions 112 which are arranged symmetrically along the outer circumference of the columnar body. The columnar body has a central hole 140. A generator stator winding is arranged in the three arc-shaped protrusions 112. The motor stator 130 is tubular and has three arc-shaped protrusions 132 symmetrically arranged along its inner wall. The three arc-shaped protrusions are used to wind a motor stator winding. The rotator 120 is substantially tubular, and is consisted of three first partial tubular members 122, 124, and 126, which have a first inner diameter and a first outer diameter, and three second partial tubular members 121, 123, and 125, which have a second inner diameter and a second outer diameter, and the three first partial tubular members 122, 124, 126 and the three second partial tubular members 121, 123, 125 are connected alternately with each other, wherein the first inner diameter is less than the second inner diameter, the first outer diameter is less than the second outer diameter, and the first outer diameter may be equal to the second inner diameter. The first partial tubular members 122, 124 and 126 of the rotator 120 are wound with a generator rotator winding, while the second partial tubular members 121, 123 and 125 of the rotator 120 are wound with a motor rotator winding, but the generator rotator winding is disconnected with the motor rotator winding. In such a way, the rotator 120 is shared as the generator rotator and the motor rotator. The inner generator stator 110 interacts with the rotator 120 to form a generator, and the outer motor stator 130 interacts with the rotator 120 to form a motor, thereby a generator motor integrated with the generator and the motor is achieved.

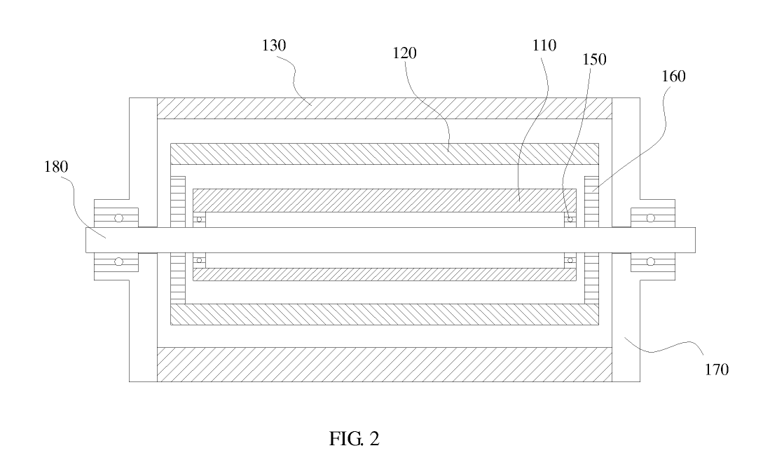

FIG. 2 is a assembly diagram of the generator motor as shown in FIG. 1. As shown in FIG. 2, the generator motor comprises a rotating shaft 180 for outputting torque. The generator stator 110 is rotatablely installed on the rotating shaft 180 via bearings 150. The rotator 120 is fixedly installed on the rotating shaft 180 at the inner wall of the first partial tubular members 122, 124 and 126 via sleeves 160. The motor stator 130 is rotatablely installed on the rotating shaft 180 via bearing end covers 170. The above-mentioned components constitute a core portion of the generator motor. The core portion may be supported in the housing through the rotating shaft, and also may be provided with a frame for connection with other application structures. Since these are prior art, detailed description with respect to these structures is omitted in the present application.

Working principle of the generator motor will be described in conjunction with the first embodiment of the present application as below:

When the motor stator wingding of the outer motor stator 130 is connected to external power supply, interaction between the motor stator winding and the motor rotator winding arranged on the second partial tubular members 121, 123 and 125 of the rotator 120 generates electromagnetic torque, which drives the rotator 120 rotating, in turn drives the shaft 180 rotating, then electric energy is converted into mechanical energy. The output torque of the shaft 180 then drives a central shaft or associated mechanical shafts of the automobile rotating. During the rotation of the shaft 180 driven by the rotator 120, the generator rotator winding arranged on the first partial tubular members 122, 124 and 126 of the rotator 120 cuts magnetic line in the magnetic filed produced by the generator stator 110 to generate induced current. The induced current is outputted from the generator rotator winding and is supplied to the storage cell after being processed, then mechanical energy is converted into electric energy. Then, the storage cell may supply power to the motor portion of the generator motor to drive the rotator 120 again, and rotation of the rotator 120 then generates induced current to supplement electric quantity of the storage cell. In such a manner of recycling, power consumption of the motor is significantly reduced, and recycling and reuse of kinetic energy is achieved.

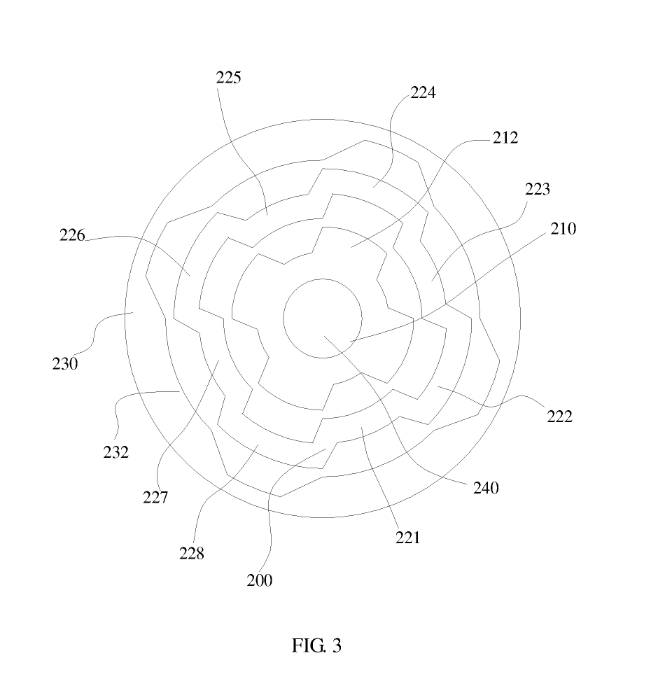

FIG. 3 is a structural diagram showing a generator motor in accordance with a second embodiment of the present application. As shown in FIG. 3, a generator stator 210, a rotator 220 and a motor stator 230 are arranged sequentially from inside to outside within a housing (not shown) of the generator motor. The second embodiment as shown in FIG. 3 has a similar structure as the first embodiment shown in FIG. 1. The generator stator 210 comprises a columnar body and four arc-shaped protrusions 212 which are arranged symmetrically along the outer circumference of the columnar body. The columnar body has a central hole 240. A generator stator winding is arranged in the four arc-shaped protrusions 212. The motor stator 230 is tubular and has four arc-shaped protrusions 132 symmetrically arranged along its inner wall. The four arc-shaped protrusions are used to wind a motor stator winding. The rotator 220 is substantially tubular, and is consisted of four first partial tubular members 222, 224, 226 and 228, which have a first inner diameter and a first outer diameter, and four second partial tubular members 221, 223, 225 and 227, which have a second inner diameter and a second outer diameter, and the four first partial tubular members 222, 224, 226, 228 and the four second partial tubular members 221, 223, 225, 227 are connected alternately with each other, wherein the first inner diameter is less than the second inner diameter, the first outer diameter is less than the second outer diameter, and the first outer diameter may be equal to the second inner diameter. The first partial tubular members 222, 224, 226 and 228 of the rotator 220 are wound with a generator rotator winding, while the second partial tubular members 221, 223, 225 and 227 of the rotator 220 are wound with a motor rotator winding, but the generator rotator winding is disconnected with the motor rotator winding. In such a way, the rotator 220 is shared as the generator rotator and the motor rotator. The inner generator stator 210 interacts with the rotator 220 to form a generator, and the outer motor stator 230 interacts with the rotator 220 to form a motor, thereby a generator motor integrated with the generator and the motor is achieved.

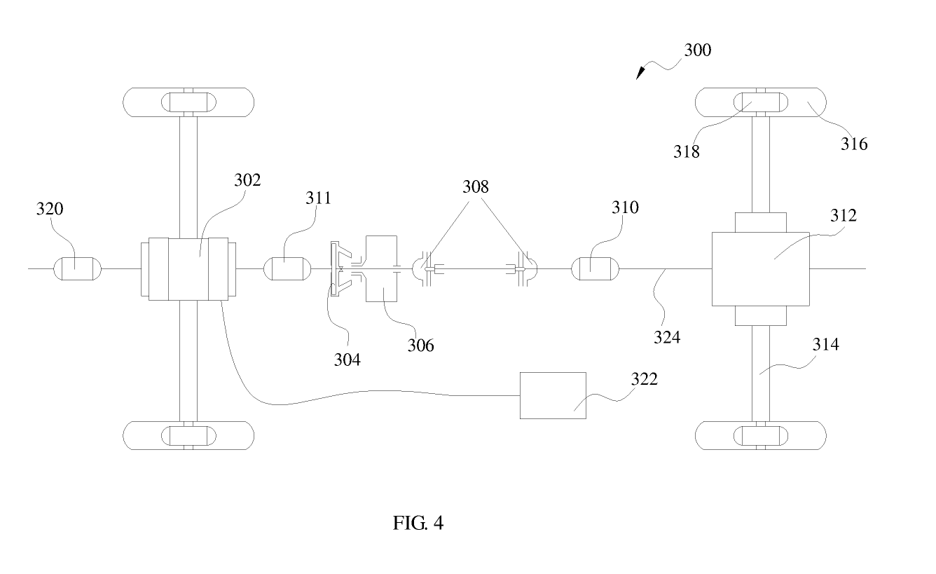

FIG. 4 is a diagram showing a transmission system of an electric automobile 300 driven by a generator motor in accordance with an embodiment of the present application. As shown in FIG. 4, the electric automobile 300 is driven by a generator motor 302. The rotating shaft of the generator motor 302 is connected to the central shaft 324 of the automobile via a clutch 304. Then, the output torque from the generator motor 302 is decelerated via a gear box 306, and transmitted to a differential gear 312 through a universal joint 308, and then transmitted to a set of rear wheels 316 through a half shaft 314. The clutch 304, the gear box 306, the universal joint 308, the differential gear 312 and the transmission thereof may be realized through various technical means in the prior art, so detailed discussion regarding this portion is omitted here.

As shown in FIG. 4, the electric automobile includes a storage cell 322 for providing power supply to the generator motor 302. The storage cell is electrically connected to the motor stator winding of the generator motor 302 via wires. When the generator motor 302 is initiated to run utilizing power supply from the storage cell 322, the generator motor 302 drives the central shaft 324 rotating, in turn drives the automobile traveling forward. After the generator motor 302 is initiated to run, the generator portion of the generator motor 302 outputs electric current to the storage cell 322 continuously. That is, kinetic energy of rotation of the generator motor 302 is sufficiently reused and converted into electric energy. In such a way, service time of the storage cell 322 may be prolonged.

Since electric energy generated by self power generation of the generator motor 302 is not enough to supplement the electric energy consumed by its motor portion, in the embodiment of the present application as shown in FIG. 4, the electric automobile is further provide with a generator 320 at the non-output terminal of the generator motor 302. A rotator of the generator 320 is driven by and rotates with the shaft of the generator motor 302. Electric energy generated from the generator 320 is supplied to the storage cell 322 after some necessary processing such as A/D conversion. Additionally, a further generator 311 is arranged on the shaft between the output terminal of the generator motor 302 and the clutch. A rotator of the generator 311 is driven by and rotates with the shaft of the generator motor 302, and electric energy generated from the generator 311 is also supplied to the storage cell 322 after some necessary processing. With such design of the electric automobile, electric quantity of the storage cell can not only be supplemented during the traveling through driving the generator producing electricity, but also can be supplemented when the electric automobile doesn't work. For example, when the automobile is waiting red light, idle running of the generator motor 302 may also drive the generators 311 and 320 on its shaft to generate electricity.

Further, a generator 310 is installed on the central shaft 324 of the electric automobile. The generator 310 is driven by the central shaft 324 to generate electric current to the storage cell 322. FIG. 4 shows only an embodiment of the present application, but the present application is not limited as illustrated. It can be understood by one skilled in the art that the number of the generators, which utilize rotation energy of the generator motor 302 to re-generate electricity, such as the generators 310, 311 and 320, is not limited to the illustrated embodiment in FIG. 4. Upon actual application and available chassis space, the number of the generators may be adjusted.

In order to use the output energy of the generator motor 302 more sufficiently, the electric automobile is provided with a generator 318 on each wheel of the two sets of front and real wheels 316. Running of the wheel 316 drives the generator 318 to generate electricity, and the generated electric energy is transmitted to the storage cell 322. Additionally, a plurality of small wind-driven generators may be arranged above the windscreens of the automobile so as to utilize wind energy during traveling. The generated electric energy is transmitted into the storage cell 322.

In virtue of the above-described design, the electric automobile of the present application can supplement electric quantity of the storage cell through recycling and reuse of kinetic energy converted into electric energy in the case that electric quantity of the storage cell is limited. Thus service time of the storage cell is prolonged to the utmost, then application range of the electric automobile is extended.

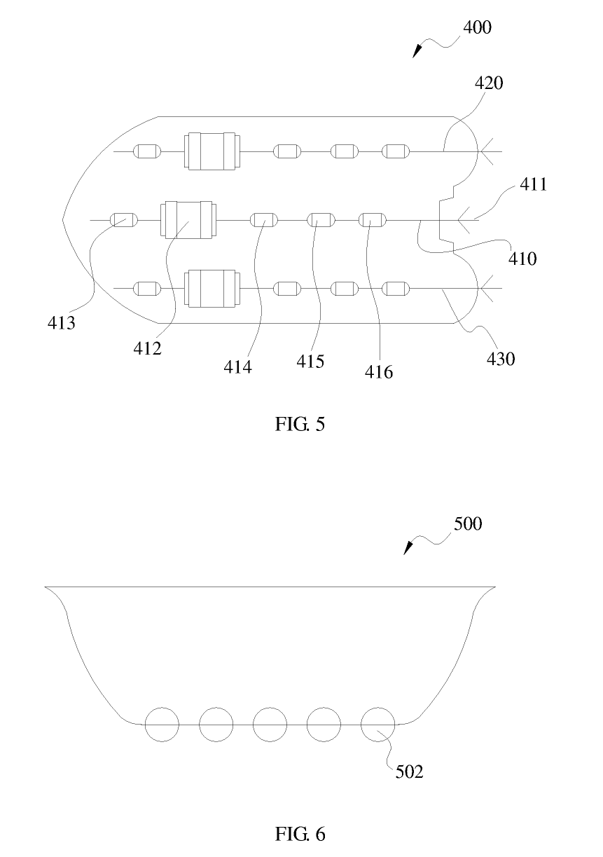

FIG. 5 is a diagram showing an electric ship 400 driven by the generator motor in accordance with an embodiment of the present application. The electric ship 400 utilizes a same driving principle as the electric automobile 300 shown in FIG. 3. As shown in FIG. 5, the electric ship 400 is driven by a generator motor 412. The generator motor 412 drives a shaft 410 and in turn a screw propeller 411 running, which pushes the ship traveling. Highpower ship are usually equipped with more than one set of propulsion systems, for example, in the embodiment as shown in FIG. 5, there are three sets of propulsion systems. Each set of the propulsion system is provided with a generator motor for driving the corresponding shafts 410, 420 and 430 rotating to run the respective screw propellers.

The generator motors in the individual sets of propulsion systems of the electric ship 400 are powered by the storage cells. For example, when the generator motor 412 is initiated to run utilizing power supply of the storage cell, it drives the shaft 410 rotating, which in turn drives the screw propeller 411 running. When the generator motor 412 is running, its generator portion starts generating electricity, kinetic energy of rotation of the generator motor 412 is converted into electric energy stored in the storage cell. Further, in order to use kinetic energy of rotation sufficiently, at the non-output terminal and the output terminal of the generator motor in each set of propulsion system, at least one generator is installed respectively, which is driven by the corresponding generator motor. For example, in the embodiment as shown in FIG. 5, a generator 413 is installed at the non-output terminal of the generator motor 412. A rotator of the generator 413 runs with rotation of the shaft of the generator motor 412, and the generated electric energy is supplied to the storage cell to supplement its electric quantity after some necessary processing such as A/D conversion. Three additional generators 414, 415 and 416 are installed on the shaft 410. They are all driven by the shaft 410 to generate electricity, which is provided to the storage cell.

FIG. 6 is an electric ship 500 in accordance with another embodiment of the present application. The electric ship 500 may utilize the same propulsion system as in the electric ship 400 shown in FIG. 5. That is, the screw propeller is driven by motive power from the generator motor, which runs with power supply from the storage cell, and the storage cell is supplemented by self generated electricity of the generator motor and electric energy generated by the individual generators driven by the generator motor. In such a way, recycling and reuse of kinetic energy is achieved. The electric ship 500 shown in FIG. 6 is further equipped with a group of plurality of hydraulic turbines 502. The hydraulic turbines 502 are driven by water flow during traveling of the ship 500 to generate electricity. The generated electric energy may be supplied to the storage cell, or directly supplied to various consumer devices on the ship 500.

1-10. (canceled)

11. A generator motor, comprising a rotating shaft, a generator stator, a rotator, and a motor stator, the generator stator, the rotator, and the motor stator are installed on the rotating shaft sequentially from inside to outside, wherein the generator stator has a plurality of first protrusions symmetrically distributed along its circumferential direction, and a generator stator winding is arranged on said plurality of first protrusions; the motor stator has a plurality of second protrusions extending inward and symmetrically distributed along its inner wall, and a motor stator winding is arranged on said plurality of second protrusions; the rotator includes a plurality of first partial tubular members which have a first inner diameter and a first outer diameter, and a corresponding plurality of second partial tubular members which have a second inner diameter and a second outer diameter, and the plurality of first partial tubular members and the plurality of second partial tubular members are connected alternately with each other along its circumferential direction, the first inner diameter is less than the second inner diameter, and the first outer diameter is less than the second outer diameter, wherein a generator rotator winding is arranged on the plurality of first partial tubular members, and a motor rotator winding is arranged on the plurality of second partial tubular members.

12. The generator motor according to claim 11, wherein the generator stator and the motor stator are installed on the rotating shaft of the generator motor via bearings respectively.

13. The generator motor according to claim 11, wherein the rotator is fixedly installed on the rotating shaft of the generator motor via sleeves.

14. An electric automobile, comprising a storage cell, a motor, a clutch, a gear box, a universal joint, a rear bridge, a differential gear, and a plurality sets of front wheels and rear wheels, motive power generated by the motor when it is powered from the storage cell to run, being transferred to the rear wheels via the clutch, the gear box, the universal joint, the rear bridge and the differential gear installed on the central shaft, and then via a half shaft, wherein the motor is a generator motor, comprising a rotating shaft, a generator stator, a rotator, and a motor stator, the generator stator, the rotator, and the motor stator are installed on the rotating shaft sequentially from inside to outside, wherein the generator stator has a plurality of first protrusions symmetrically distributed along its circumferential direction, and a generator stator winding is arranged on said plurality of first protrusions; the motor stator has a plurality of second protrusions extending inward and symmetrically distributed along its inner wall, and a motor stator winding is arranged on said plurality of second protrusions; the rotator includes a plurality of first partial tubular members which have a first inner diameter and a first outer diameter, and a corresponding plurality of second partial tubular members which have a second inner diameter and a second outer diameter, and the plurality of first partial tubular members and the plurality of second partial tubular members are connected alternately with each other along its circumferential direction, the first inner diameter is less than the second inner diameter, and the first outer diameter is less than the second outer diameter, wherein a generator rotator winding is arranged on the plurality of first partial tubular members, and a motor rotator winding is arranged on the plurality of second partial tubular members; and wherein the motor stator winding of the generator motor is connected externally to the storage cell, and electric current generated from the generator rotator winding of the generator motor is connected to the storage cell.

15. The electric automobile according to claim 14, wherein at least a generator driven by the shaft is arranged on a non-output terminal of the shaft of the generator motor, and at least another generator driven by the shaft is arranged on the shaft between the generator motor and the clutch.

16. The electric automobile according to claim 14, wherein at least a generator driven by the central shaft of the electric automobile is arranged on the central shaft to supply power to the storage cell.

17. The electric automobile according to claim 14, wherein each of the plurality sets of front wheels and rear wheels is provided with a generator which runs with rotation of the corresponding wheel to supply power to the storage cell.

18. The electric automobile according to claim 14, wherein the generator stator and the motor stator are installed on the rotating shaft of the generator motor via bearings respectively.

19. The electric automobile according to claim 14, wherein the rotator is fixedly installed on the rotating shaft of the generator motor via sleeves.

20. An electric ship, comprising at least one propulsion system, wherein in each propulsion system, a motor is powered by a storage cell to drive a screw propeller running, and said motor is a generator motor, comprising a rotating shaft, a generator stator, a rotator, and a motor stator, the generator stator, the rotator, and the motor stator are installed on the rotating shaft sequentially from inside to outside, wherein the generator stator has a plurality of first protrusions symmetrically distributed along its circumferential direction, and a generator stator winding is arranged on said plurality of first protrusions; the motor stator has a plurality of second protrusions extending inward and symmetrically distributed along its inner wall, and a motor stator winding is arranged on said plurality of second protrusions; the rotator includes a plurality of first partial tubular members which have a first inner diameter and a first outer diameter, and a corresponding plurality of second partial tubular members which have a second inner diameter and a second outer diameter, and the plurality of first partial tubular members and the plurality of second partial tubular members are connected alternately with each other along its circumferential direction, the first inner diameter is less than the second inner diameter, and the first outer diameter is less than the second outer diameter, wherein a generator rotator winding is arranged on the plurality of first partial tubular members, and a motor rotator winding is arranged on the plurality of second partial tubular members; and wherein the motor stator winding of the generator motor is connected externally to the storage cell, and electric current generated from the generator rotator winding of the generator motor is connected to the storage cell.

21. The electric ship according to claim 20, wherein on a rotating shaft of each propulsion system, at least one generator which is driven by the shaft is arranged to supply power to the storage cell.

22. The electric ship according to claim 20, wherein at the bottom of the electric ship, at least one hydraulic turbine driven by water flow is arranged.

23. The electric ship according to claim 20, wherein the generator stator and the motor stator are installed on the rotating shaft of the generator motor via bearings respectively.

24. The electric ship according to claim 20, wherein the rotator is fixedly installed on the rotating shaft of the generator motor via sleeves.
